(19) United States
(12) Patent Application Publication
(10) Pub. No.: US 2026/0177162 A1
(43) Pub. Date: Jun. 25, 2026

(54) FLUID CONTROL VALVE AND FLUID CONTROL DEVICE

(71) Applicant: HORIBA STEC, Co., Ltd., Kyoto-shi, Kyoto (JP)

(72) Inventors: Shigeyuki HAYASHI, Irvine, CA (US); Kazuya SHAKUDO, Irvine, CA (US)

(21) Appl. No.: 19/127,902

(22) PCT Filed: Nov. 8, 2023
(86) PCT No.: PCT/JP2023/040288

§ 371 Date: May 7, 2025

(30) Foreign Application Priority Data
Nov. 10, 2022 (JP) 2022-180351

(51) Int. Cl. F16K 31/06; F16K 27/02; F16K 37/00

(52) U.S. Cl. CPC F16K 31/0655; F16K 27/029; F16K 37/005

(57) ABSTRACT

This invention is a fluid control valve that can be used in a semiconductor manufacturing process, while keeping a structure of the fluid control valve simple and reducing its dead volume. The fluid control valve comprises a flow channel block 2 on which an internal flow channel 2R is formed, a valve seat member 5 that has a valve seat surface 5a, and a valve member 6 that has a seating surface 6a that seats on the valve seat surface 5a and that is provided with a permanent magnet 60 sealed by a corrosion-resistant alloy, and an actuator 7 that drives the valve member 6 by acting on the permanent magnet 60.

### TECHNICAL FIELD

This invention relates to a fluid control valve and a fluid control device.

### BACKGROUND

Conventionally, as shown in Patent Document 1, a so-called energized closed type (normally open type) solenoid valve is considered as a fluid control valve.

The solenoid valve comprises a valve body having a valve seat, a plunger that is arranged movably up and down in the valve body, a suction cup that is arranged opposite to the plunger, an electromagnetic coil that energizes the suction cup, a valve member that is connected to the plunger and movable up and down in relation to the valve seat, and an urging member that applies a force to the plunger in a direction of opening the valve. The solenoid valve is so configured that the plunger moves to a direction of closing the valve member by resisting against an urging force of the urging member when the electromagnetic coil is energized. Concretely, the valve member is arranged to move up and down relative to the valve body arranged below the suction cup while penetrating the suction cup and is connected to the plunger arranged above the suction cup and is urged upward (in the direction of opening the valve member) on a constant basis together with the plunger.

### PRIOR ART DOCUMENTS

### Patent Documents

Patent document 1: Japanese Unexamined Patent Application Publication No. 2020-148255

### SUMMARY

### Problem to be Solved

However, there is a problem that the above-mentioned solenoid valve has a complex structure and a large dead volume. Specifically, in case that the solenoid valve is used in a process gas supply line in a semiconductor manufacturing device, it is preferable to reduce the gas-contacting area with the process gas, however, it is difficult to reduce the gas-contacting area with the above-mentioned solenoid valve because of its large dead volume.

Therefore, the present invention is made to solve the above-mentioned problem, and its main objective is to reduce the dead volume while keeping the valve structure simple, and to be able to use it in semiconductor manufacturing processes.

### Solution to Problem

More specifically, a fluid control valve in accordance with this invention comprises a flow channel block on which an internal flow channel is formed, a valve seat member that has a valve seat surface, a valve member that has a seating surface that seats on the valve seat surface and that is provided with a permanent magnet, and an actuator that drives the valve member by acting on the permanent magnet, and is characterized by that the permanent magnet is sealed by a corrosion-resistant alloy.

The corrosion-resistant alloy in this specification is an alloy that is resistant to a gas, used in semiconductor manufacturing processes, and concretely, a halogen gas such as fluorine (F₂), chlorine (Cl₂), bromine (Br₂), iodine (I₂), or compounds containing a halogen element, for example, a halogen-based gas such as HCl or the like.

In addition, the corrosion-resistant alloy is made of a material different from a permanent magnet and has higher corrosion resistance than the permanent magnet. More preferably, the corrosion-resistant alloy has higher corrosion resistance than the permanent magnet to gases used in semiconductor processes. Concretely, the corrosion-resistant alloy has higher corrosion resistance than the permanent magnet to the halogen gas such as fluorine (F₂), chlorine (Cl₂), bromine (Br₂), iodine (I₂), or compounds containing a halogen element, for example, a halogen-based gas such as HCl or the like.

In addition to being resistant to the above-mentioned gas, the corrosion-resistant alloy is also preferably resistant to reaction products (mainly strong acids) and aqueous solutions produced when halogen or a halogen-based gas reacts with moisture.

In accordance with the fluid control valve having this configuration, since the permanent magnet is provided on the valve member, and the valve member is driven by acting on the permanent magnet, it is possible to simplify the valve structure compared with a conventional structure using a plunger, and to reduce the dead volume.

Especially in this present invention, since the permanent magnet is sealed by the corrosion-resistant alloy, even if the permanent magnet is used in a semiconductor manufacturing process, it is possible to prevent the permanent magnet from being corroded by the process gas.

Therefore, it is possible to preferably use the fluid control valve of the present invention in a process gas supply line of a semiconductor manufacturing device, and to reduce the gas-contacting area with the process gas.

As a concrete embodiment of the actuator conceived is an actuator that comprises a core provided on an opposite side to the seating surface of the valve member, and a solenoid coil wound around the core.

In this configuration, in case that the fluid control valve is, so called, of an energized closed type (normally open type), at a time when the solenoid coil is not energized, the permanent magnet is adsorbed to the core, causing the valve member to be fully open, and at a time when the solenoid coil is energized, the core and the permanent magnet repel each other, causing the valve member to move in the direction of closing the valve.

As a concrete embodiment to seal the permanent magnet with a corrosion-resistant alloy, it is preferable that the valve member comprises a valve body that is made of a corrosion-resistant alloy and that is provided with a recess to house the permanent magnet on a surface opposite to the seating surface, and a sealing member that is made of a corrosion-resistant alloy and that seals an opening of the recess in a state wherein the permanent magnet is housed in the recess.

In accordance with this configuration, since it is possible to seal the permanent magnet with the corrosion-resistant alloy just by housing the permanent magnet in the recess of the valve body and by sealing the permanent magnet, it is possible to simplify a structure of the valve member.

As a concrete embodiment of the corrosion-resistant alloy represented is stainless steel such as, for example, SUS316L.

The core of the actuator is provided on a side opposite to the seating surface of the valve member, and in order to prevent the magnetic coupling between the core and the permanent magnet from being disturbed, it is preferable that the valve body is made of electromagnetic stainless steel, and the sealing member is made of non-magnetic stainless steel. In addition, in order to make the valve body function as a yoke and to strengthen the magnetic coupling between the core and the permanent magnet, it is preferable that the valve body is made of electromagnetic stainless steel.

In addition, the fluid control valve in accordance with this invention preferably further comprises a distance adjustment mechanism that adjusts distance between the core and the valve member.

By adjusting the distance between the core and the valve member using this distance adjustment mechanism, it is possible to adjust (increase or decrease) the distance to achieve an optimal magnetic field (magnetic flux density). For example, in case of controlling a minute amount of a flow rate, the magnetic coupling between the core and the valve member is weakened by increasing the distance between the core and the valve member, thereby enabling control of the minute amount of the flow rate.

As a concrete embodiment of the fluid control valve conceived is a fluid control valve that further comprises a mounting block that is mounted on the flow channel block and that houses the valve member, and the actuator has a casing that houses the core and the solenoid coil, and the core is fixed to the casing.

In accordance with this configuration, since it is possible to dismount the actuator together with the valve member by dismounting the mounting block from the flow channel block, it becomes easy to disassemble the fluid control valve, thereby facilitating maintenance. In addition, the core is provided on the side opposite to the seating surface of the valve member by mounting the casing to the mounting block.

In this configuration, a concrete embodiment of the distance adjustment mechanism is preferably configured by the casing and the mounting block.

As a concrete embodiment of the distance adjustment mechanism, it is conceivable that the distance adjustment mechanism has a male screw unit that is formed on either one of an outer circumference of the casing and the mounting block, and a female screw unit that is formed on the other of the outer circumference of the casing and the mounting block and into which the male screw unit screws.

In accordance with this configuration, the distance between the core and the valve member can be adjusted by a simple operation of rotating the casing with respect to the mounting block.

It is preferable that the mounting block is provided with a fixing unit that is movable back and forth in relation to the casing and that fixes the casing to the mounting block.

In accordance with this configuration, it is possible to securely keep the distance between the core and the valve member by fixing the casing using the fixing unit after adjusting the distance between the core and the valve member using the distance adjustment mechanism.

As a concrete embodiment for fixing the casing by the fixing unit, it is preferable that the casing has a cylindrical end unit at a distal end part on a flow channel block side, the mounting block has a slit that houses the cylindrical end unit, the fixing unit is provided on a side wall part that forms the slit of the mounting block, and the cylindrical end unit is fixed to the side wall part that forms the slit of the mounting block by the fixing unit.

In order to make it easy to disassemble and assemble the fluid control valve and to facilitate maintenance of the fluid control valve, it is preferable that the flow channel block has a housing recess that houses the valve seat member.

In addition, in order to facilitate assembling the fluid control valve, it is preferable that the mounting block fixes the valve seat member housed in the housing recess by being mounted on the flow channel block.

Furthermore, the fluid control device in accordance with this invention is characterized by comprising the above-mentioned fluid control valve, a fluid sensor that measures a flow rate or a pressure of a fluid, and a control unit that controls an opening degree of the fluid control valve based on a measured value measured by the fluid sensor and a predetermined target value.

### Effect

In accordance with the present invention having the above configuration, the dead volume can be reduced while the valve structure is simplified, and the fluid control device can be used in semiconductor manufacturing processes.

### BRIEF DESCRIPTION OF THE DRAWINGS

FIG. 1 is a schematic view of a fluid control device in accordance with one embodiment of the present invention.

FIG. 2 is a cross-sectional view of the fluid control valve in accordance with the same embodiment.

FIG. 3 is a perspective view and a cross-sectional view showing a configuration of the valve member in accordance with the same embodiment.

FIG. 4 is a partially enlarged cross-sectional view of the fluid control valve (open valve state) in accordance with the same embodiment.

FIG. 5 is a partially enlarged cross-sectional view of the fluid control valve (closed valve state) in accordance with the same embodiment.

FIG. 6 is a partially enlarged cross-sectional view showing a state before and after the distance is adjusted in accordance with the same embodiment.

FIG. 7 is a partially enlarged cross-sectional view of the fluid control valve (open valve state) in accordance with a modified embodiment.

### DETAILED DESCRIPTION

One embodiment of a fluid control device using a fluid control valve of the present invention will be explained with reference to drawings.

For the sake of clarity, any of figures shown below is schematically drawn by omitting or exaggerating parts as appropriate. The same symbol is used to represent the same component, and the description of such components is omitted as appropriate.

### Device Configuration

The fluid control device 100 of this embodiment is used in, for example, the semiconductor manufacturing process by being incorporated into a semiconductor manufacturing device and is provided in one or more gas supply lines connected to, for example, a semiconductor processing chamber and controls a flow rate of a process gas flowing through each of the gas supply lines.

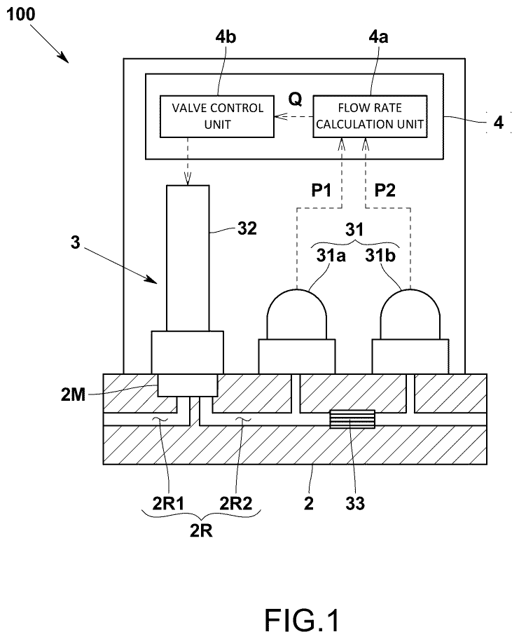

Concretely, the fluid control device 100 is a so-called differential pressure mass flow controller (differential pressure MFC), and as shown in FIG. 1, the fluid control device 100 comprises a flow channel block 2 having an internal flow channel 2R, and fluid control equipment 3 including a flow sensor 31 and a fluid control valve 32 mounted on the flow channel block 2.

The flow channel block 2 is a rectangular shape, and the flow sensor 31 and the fluid control valve 32 are provided on a predetermined surface of the flow channel block 2. In addition, the flow channel block 2 has a concave-shaped housing recess 2M on a predetermined surface of which the fluid control valve 32 is mounted, and the internal flow channel 2R is divided into an upstream side flow channel 2R1 and a downstream side flow channel 2R2 by the housing recess 2M. An opening of one end of the upstream side flow channel 2R1 is formed, for example, on a bottom surface of the housing recess 2M, and an opening of the downstream side flow channel 2R2 is formed, for example, on the bottom surface of the housing recess 2M.

The fluid control equipment 3 controls the fluid in the internal flow channel 2R and has the flow sensor 31 that measures the flow rate of the fluid flowing through the internal flow channel 2R, and the fluid control valve 32 that is provided on an upstream side of the flow sensor 31. A valve opening of the fluid control valve 32 is feedback-controlled by a control unit 4, to be described later.

The flow sensor 31 is a differential pressure type flow sensor and has an upstream side pressure sensor 31a arranged on an upstream side of a fluid resistance element 33 such as a restrictor or an orifice arranged in the internal flow channel 2R, and a downstream side pressure sensor 31b arranged in a downstream side of the fluid resistance element 33. The upstream side pressure sensor 31a and the downstream side pressure sensor 31b are mounted in a single line together with the flow control valve 32 on the predetermined surface of the flow channel block 2. A flow rate (Q) flowing through the internal flow channel 2R is calculated by the flow rate calculation unit 4a of the control unit 4, to be described later, using an upstream side pressure P1 of the fluid resistance element 33 detected by the upstream side pressure sensor 31a and a downstream side pressure P2 of the fluid resistance element 33 detected by the downstream side pressure sensor 31b.

The fluid control valve 32 is provided on the upstream side of the differential pressure type flow sensor 31. Concretely, the fluid control valve 32 is a solenoid valve (electromagnetic valve) that controls the flow rate by moving a valve member 6 advanced or retracted relative to the valve seat using a solenoid. In this embodiment, it is a so-called normally open type that is fully open in a state wherein the valve member 6 is not driven. The fluid control valve 32 is controlled by a valve control unit 4b of the control unit 4. A detailed configuration of the fluid control valve 32 will be described later.

The control unit 4 has the flow rate calculation unit 4a that calculates the flow rate (Q) flowing through the internal flow channel 2R based on the upstream side pressure Pl and the downstream side pressure P2, and the valve control unit 4b that controls the fluid control valve 32 based on the flow rate (Q) calculated by the flow rate calculation unit 4a and the target flow rate (set value). The control unit 4 is a so-called computer that comprises a CPU, a memory, an A/D converter and a D/A converter, and an input means and an output means, and the control unit 4 performs functions of the flow rate calculation unit 4a and the valve control unit 4b by executing the flow rate control programs stored in the memory and having various devices work together.

### Detailed Configuration of the Fluid Control Valve 32

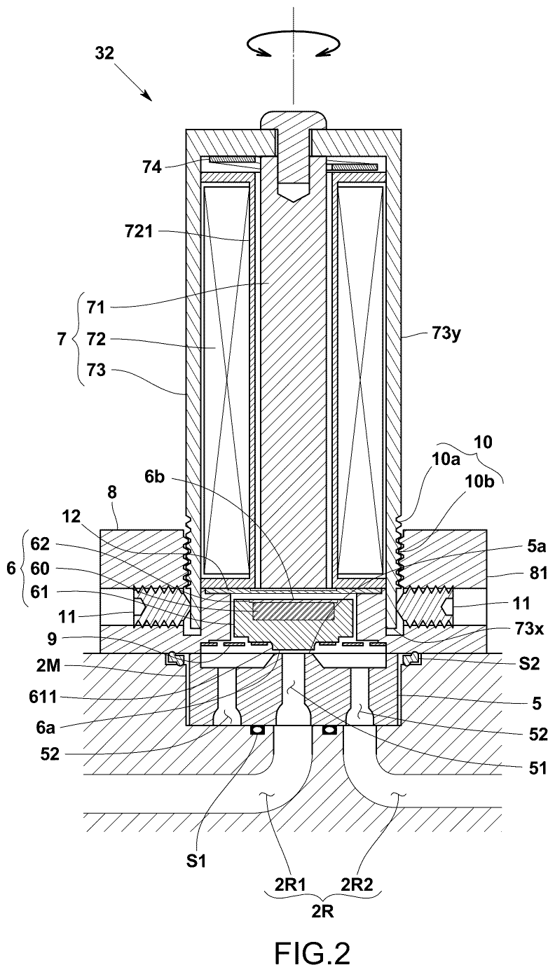

As shown in FIG. 2 to FIG. 5, the fluid control valve 32 of this embodiment comprises a valve seat member 5 having a flat valve seat surface 5a, a valve member 6 having a flat seating surface 6a that is in face contact with the valve seat surface 5a and having a permanent magnet 60, and an actuator 7 that drives the valve member 6 by acting on the permanent magnet 60.

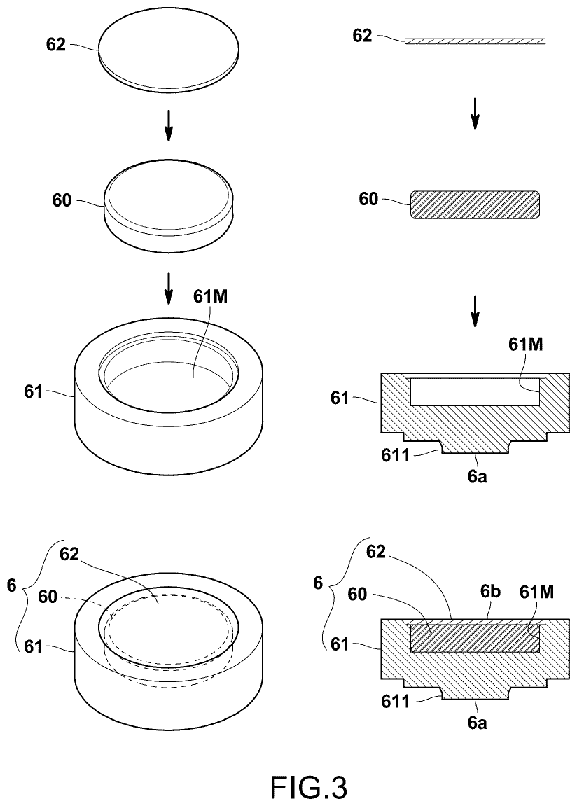

The valve seat member 5 has a roughly rotational body shape, as shown in FIG. 2 and FIG. 3, and is housed in the housing recess 2M of the flow channel block 2. The valve seat member 5 has the circular valve seat surface 5a formed on a top surface facing an opening side of the housing recess 2M. The valve seat member 5 is made of a non-magnetic material, such as austenitic stainless steel (non-magnetic stainless steel) such as SUS316L.

In addition, the valve seat member 5 has a through-hole 51, formed in a center of an inside of the valve seat surface 5a, and which penetrates from the valve seat surface 5a side to the opposite side of the valve seat surface 5a. The through-hole 51 is connected to the upstream side flow channel 2R1 which opens to a bottom surface of the housing recess 2M. A seal member S1 such as an O-ring is arranged between a circumference of the through-hole 51 and the bottom surface of the housing recess 2M, and the through-hole 51 is liquid-tightly sealed.

Furthermore, the valve seat member 5 has a guide channel 52 that drains the fluid that has flowed into the inside from the valve seat surface 5a to the downstream side flow channel 2R2. The guide channel 52 of this embodiment is a through-hole that penetrates from the valve seat surface 5a side to a side opposite the valve seat surface 5a. The guide channel 52 is connected to the upstream side flow channel 2R1, which opens to the bottom surface of the housing recess 2M.

The valve member 6 is roughly in a shape of a rotating body, as shown in FIG. 2 to FIG. 5, and is arranged opposite to the valve seat member 5 housed in the housing recess 2M. In addition, the permanent magnet 60 arranged on the valve member 6 is disc-shaped and is sealed with a corrosion-resistant alloy that is resistant to the gases used in semiconductor processes. In this embodiment, the permanent magnet 60 can be an alloy magnet such as an AlNiCo magnet, a ferrite magnet, or a rare earth magnet such as a neodymium magnet.

Concretely, the valve member 6 has a valve body 61 to which a recess 61M which houses the permanent magnet 60 in a surface opposite to the seating surface 6a, and a sealing member 62 that seals an opening of the recess 61M with the permanent magnet 60 housed in the recess 61M. The permanent magnet 60 of this embodiment has a structure that is sealed by the valve body 61 and the sealing member 62.

The valve body 61 is roughly in a shape of a rotating body and has a convex 611 with a flat seating surface 6a on its top surface. The valve body 61 of this embodiment has the circular seating surface 6a corresponding to the circular valve seat surface 5 a. In addition, the recess 61M has a shape corresponding to the permanent magnet 60, and in this embodiment, the recess 61M is roughly circular in a plane view. The valve body 61 is made of a corrosion-resistant alloy such as stainless steel which is resistant to the gases used in semiconductor processes. The valve body 61 of this embodiment is made of a magnetic material such as an electromagnetic stainless steel such as KM45 in order to function as a yoke.

The sealing member 62 has a roughly disc shape corresponding to the opening shape of the recess 61M. The sealing member 62 seals the opening of the recess 61M to prevent the permanent magnet 60 housed in the recess 61M from corroding. In addition, the sealing member 62 is joined to the opening of the recess 61M by welding, for example, by laser welding. The sealing member 62 may also be mechanically or adhesively bonded to the opening of the recess 61M. The sealing member 62 is made of a corrosion-resistant alloy, such as stainless steel, which is resistant to the gases used in semiconductor processes. The sealing member 62 of this embodiment is made of a non-magnetic material such as austenitic stainless steel (non-magnetic stainless steel) such as, for example, SUS316L, so as not to interfere with the magnetic coupling between a core 71 and the permanent magnet 60.

This valve member 6 is housed in a mounting block 8 that is mounted on the predetermined surface (the top surface) of the flow channel block 2. The mounting block 8 is made of a non-magnetic material, such as austenitic stainless steel (non-magnetic stainless steel) such as SUS316L. The valve member 6 is supported by a support member 9 made of an elastic material such as, for example, a plate spring relative to the mounting block 8. The support member 9 supports the valve member 6 in a state wherein the seating surface 6a of the valve member 6 faces the valve seat surface 5a side. Concretely, the support member 9 is a circular ring, and the convex 611 of the valve member 6 is inserted into a center opening 91 of the support member 9 to support the valve member 6. In addition, the support member 9 and the valve member 6 may also be integrated by welding, for example, by laser welding. The joining of the support member 9 and the valve member 6 to form a single structure may be by mechanical joining or adhesive joining. In addition, the support member 9 is made of a non-magnetic material such as austenitic stainless steel, for example, SUS316L. Furthermore, the support member 9 has spring properties and is made of a corrosion-resistant material suitable for a semiconductor contact gas unit that takes into consideration of magnetic permeability.

In addition, the mounting block 8 also fixes the valve seat member 5 housed in the housing recess 2M by being mounted on the flow channel block 2. Concretely, a surface (a bottom surface), facing the flow channel block 2 of the mounting block 8, makes contact with the top surface of the valve seat member 5, and the bottom surface of the valve seat member 5 is pressed against the bottom surface of the housing recess 2M through the seal member S1 to fix the valve seat member 5 to the housing recess 2M. In addition, a seal member S2 such as a metal seal is arranged between the mounting block 8 and the flow channel block 2, and the space therebetween is liquid-tightly sealed.

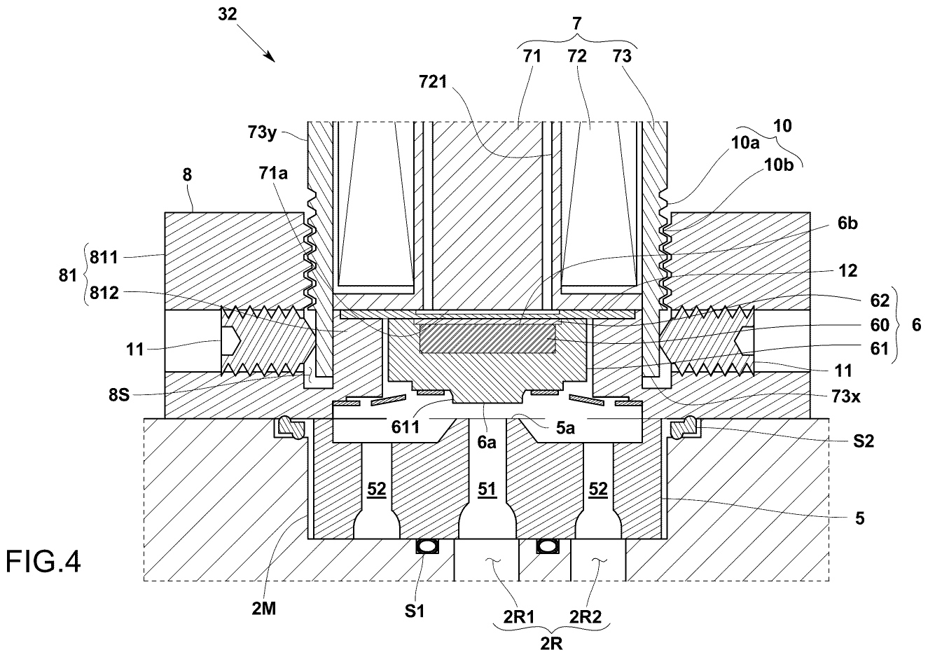

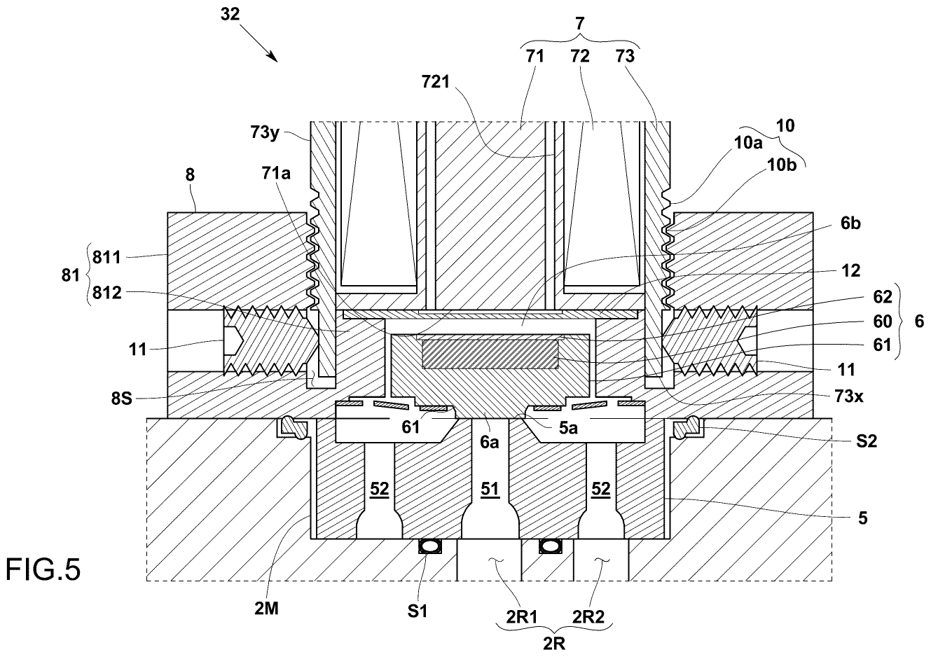

As shown in FIG. 2, FIG. 4 and FIG. 5, the actuator 7 has the core 71 that is arranged on a surface 6b opposite to the seating surface 6a of the valve member 6, a solenoid coil 72 that is wound around the core 71, and a casing 73 that houses the core 71 and solenoid coil 72.

The core 71 has a roughly cylindrical shape, while one end part (the upper end part in FIG. 2) is connected to the casing 73, and the other end part (the lower end part in FIG. 2) faces the surface 6b opposite to the seating surface 6a of the valve member 6. Concretely, the other end part of the core 71 is opposite to the surface 6b of the valve member 6 so as to be coaxial to the permanent magnet 60 arranged in the valve member 6. The core 71 is made of a magnetic material, such as a carbon steel material for machine structural use, such as S45C.

The solenoid coil 72 is arranged to be wound around an outer circumference of the core 71 and is concretely wound around a bobbin 721 into which the core 71 is inserted. In this embodiment the bobbin 721 is arranged to be slidably movable relative to the core 71. The bobbin 721 is made of a non-magnetic material such as austenitic stainless steel, for example SUS316L.

The casing 73 has a cylindrical shape, and an upper wall part of the casing 73 is connected to the upper end part of the core 71. In addition, an elastic body 74 such as a wave spring is arranged between the upper wall part of the casing 73 and the solenoid coil 72 (concretely, the upper end part of the bobbin 721) (refer to FIG. 2). The casing 73 is made of a magnetic material such as a carbon steel material for machine structural use, for example, S45C. The casing 73 and core 71 may also be integrated.

In addition, the casing 73 is mounted on the mounting block 8, and the core 71 connected to the casing 73 is positioned to face the surface 6b that is opposite to the seating surface 6a of the valve member 6 by mounting the casing 73 on the mounting block 8.

The casing 73 extends to a position surrounding the valve member 6 and forms a magnetic path that guides the magnetic flux generated by the solenoid coil 72 around the valve member 6. The position surrounding the valve member 6 is a position that is opposite to an outer circumference of the valve member 6 in a direction that is orthogonal to the direction of the movement of the valve member 6. In accordance with this configuration, the surface 6b (the top surface in FIG. 2 and FIG. 3) opposite to the seating surface 6a of the valve member 6 is located on the core 71 side (the upper side) rather than a distal end surface (the lower surface in FIG. 2 and FIG. 3) on the flow channel block 2 side of the casing 73. Concretely, the casing 73 extends to a position that surrounds at least an upper half of the outer circumference of the valve member 6 in the circumference of the valve member 6 in a state wherein the valve member 6 is closed.

Furthermore, as shown in FIG. 2, FIG. 4 and FIG. 5, this embodiment comprises a distance adjustment mechanism 10 for adjusting a distance between the core 71 and the valve member 6. By adjusting the distance between the core 71 and the valve member 6 using the distance adjustment mechanism 10, the distance between the core 71 and the permanent magnet 60 is adjusted.

The distance adjustment mechanism 10 adjusts the distance between opposing surfaces of the core 71 and the valve member 6 and is interposed between the casing 73 and the mounting block 8. The distance adjustment mechanism 10 comprises the casing 73 and the mounting block 8. In this embodiment, the opposing surfaces of the core 71 and the valve member 6 are the lower end surface 71a of the core 71 and the surface 6b opposite to the seating surface 6a of the valve member 6.

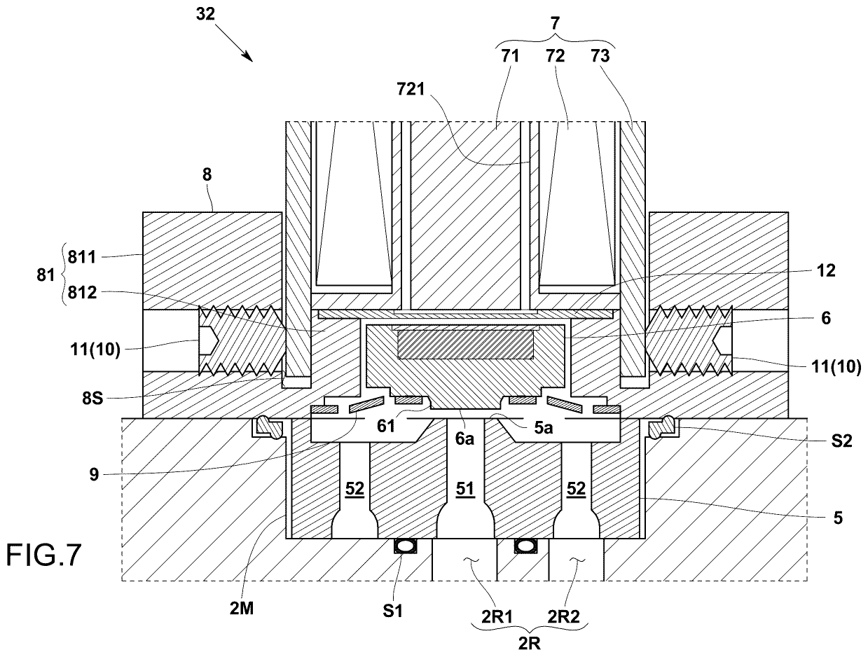

Concretely, the distance adjustment mechanism 10 has a male screw unit 10a that is formed on an outer circumference of the casing 73 and a female screw unit 10b that is formed on the mounting block 8 and into which the male screw unit 10a screws. In accordance with this configuration, the casing 73 is mounted on the mounting block 8 by screwing the male screw unit 10a and female screw unit 10b together. In addition, the casing 73 is axially advanced or retracted relative to the mounting block 8, and the distance between the mutually facing surfaces of the core 71 and the valve member 6 is adjusted by rotating the casing 73 relative to the mounting block 8 as shown in FIG. 7.

In this embodiment, as shown in FIG. 2, and FIG. 4 to FIG. 6, the mounting block 8 is provided with a set screw 11 as a fixing unit that can make an advancing or retreating movement relative to the casing 73 and that fixes the casing 73 to the mounting block 8 on a side wall part 81 where the female screw unit 10b is formed. The set screw 11 can make an advancing or retreating movement in a direction that is perpendicular to the direction of movement of the casing 73 by the distance adjustment mechanism 10.

Concretely, as shown in FIG. 2, FIG. 4 to FIG. 6, the casing 73 has a cylindrical end unit 73x at a distal end locating nearer a flow channel block side than the male screw unit 10a, and the set screw 11 makes a contact with the cylindrical end unit 73x to fix the casing 73 to the mounting block 8. The cylindrical end unit 73x of this embodiment has the same diameter as that of the main body 73y of the casing 73, which houses the solenoid coil 72. In other words, the casing 73 has a configuration that does not have a flange for being mounted on the mounting block 8.

More specifically, as shown in FIG. 4 and FIG. 5, the mounting block 8 has a circular slit 8S that houses the cylindrical end unit 73x, and the set screw 11 is arranged on a radially outer side wall part 811 that forms the slit 8S. In addition, a radially inner side wall part 812 that forms the slit 8S is provided so as to surround the outer peripheral surface of the valve member 6. The cylindrical end unit 73x is pressed and fixed to the radially inner side wall part 812 that forms the slit 8S by the set screw 11.

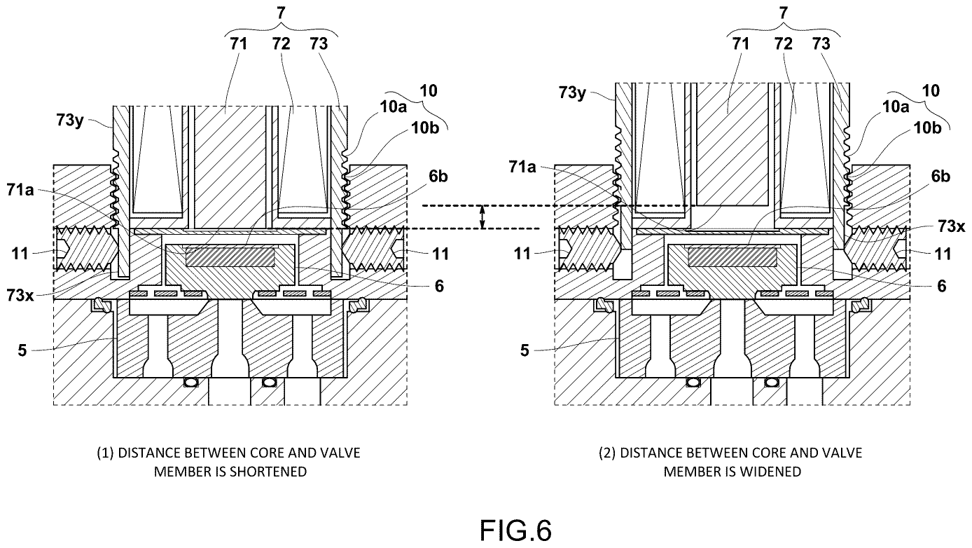

In this embodiment, even if the casing 73 and core 71 move with respect to the mounting block 8 due to the above-mentioned distance adjustment mechanism 10, the relative position between the solenoid coil 72 and mounting block 8 (valve member 6) does not change (refer to FIG. 6). Concretely, the solenoid coil 72 is provided in a manner that can make a sliding movement with respect to the core 71 and casing 73. In addition, the solenoid coil 72 is so configured to be pressed toward the mounting block 8 by a wave spring 74 arranged between an upper wall of the casing 73 and the solenoid coil 72 (an upper end of a bobbin 721). The wave spring 74 fixes the solenoid coil 72 by absorbing dimensional tolerances. It is also possible to configure the fluid control device without the wave spring 74 as far as the dimensional accuracy of each component is sufficient.

In addition, as shown in FIG. 4 and FIG. 5, a diaphragm seal 12 is provided between the lower end surface of the bobbin 721 and the upper end surface of the mounting block 8, and the diaphragm seal 12 liquid-tightly seals the space between the lower end surface of the bobbin 721 and the upper end surface of the mounting block 8. The diaphragm seal 12 is made of a nonmagnetic material such as austenitic stainless steel, for example SUS316L.

Next, an operation of the fluid control valve 32 of this embodiment will be briefly explained.

In a state wherein no current flows through the solenoid coil 72 of the actuator 7 (when it is not energized), the permanent magnet 60 arranged on the valve member 6 is adsorbed to the core 71, and the valve member 6 is in the fully open state. In this embodiment, the core 71 and the permanent magnet 60 are adsorbed to each other through the sealing member 62 and the diaphragm seal 12.

When an electric current is passed through the solenoid coil 72, a magnetic flux is generated by the solenoid coil 72, and the core 71 is magnetized. In this embodiment, in case that the core side of the permanent magnet 60 is the N-pole, the lower end part of the core 71 is magnetized to the N-pole, and when the core side of the permanent magnet 60 is the S-pole, the lower end part of the core 71 is magnetized to the S-pole. With this configuration, the magnetized core 71 and the permanent magnet 60 repel each other, causing the valve member 6 to move in the direction of closing the valve. The valve opening of the fluid control valve 32 is adjusted by controlling the current supplied to the solenoid coil 72.

### Effect of This Embodiment

In accordance with the fluid control device 100 of the embodiment having the above-mentioned configuration, since the permanent magnet 60 is provided on the valve member 6 and the valve member 6 is driven by acting on the permanent magnet 60, it is possible to make the valve structure simpler and to make the dead volume smaller compared with a conventional configuration using a plunger. Especially, in this embodiment, since the permanent magnet 60 is sealed by a corrosion-resistant alloy, even if used in a semiconductor manufacturing process, it is possible to prevent the permanent magnet 60 from being corroded by the process gas. Therefore, it is possible to use the fluid control valve 32 of this embodiment appropriately in a process gas supply line of a semiconductor manufacturing device, and to reduce the gas-contacting area with the process gas.

In addition, in this embodiment, since the sealing member 62 is made of non-magnetic stainless steel, it is possible to prevent interference with the magnetic coupling between the core 71 and the permanent magnet 60. Furthermore, since the valve body 61 is made of electromagnetic stainless steel, it is possible to make the valve body 61 function as a yoke, thereby strengthening the magnetic coupling between the core 71 and the permanent magnet 60.

Furthermore, in this embodiment, since the distance adjustment mechanism 10 that adjusts the distance between the core 71 and the valve member 6 is provided, it is possible to adjust (increase or decrease) the distance so as to achieve the optimal magnetic field (magnetic flux density) by adjusting the distance between the core 71 and the valve member 6 using the distance adjustment mechanism 10. For example, in case that a minute amount of the flow rate is to be controlled, the magnetic coupling between the core 71 and the valve member 6 will be weakened by increasing the distance between the core 71 and the valve member 6. Then. it becomes possible to control a minute amount of the flow rate.

### Other Embodiments

For example, in addition to the configuration in which the permanent magnet 60 is sealed by the valve body 61 and sealing member 62, it is also possible to have a configuration in which the permanent magnet 60 is fixed to the valve member 6 by covering the outer surface of the permanent magnet 60 with a coating member made of a corrosion-resistant alloy. By covering the permanent magnet 60 separately from the configuration of the valve member 6, it is also possible to prevent the permanent magnet 60 from corroding.

In addition to the valve body 61 made of electromagnetic stainless steel, a part or all of the valve body 61 may be made of non-magnetic stainless steel. In accordance with this configuration, it is possible to reduce the material cost of the valve member 6.

The distance adjustment mechanism 10 of the above-mentioned embodiment comprises the male screw unit 10a and the female screw unit 10b, however, as shown in FIG. 7, it may also comprise the set screw 11. In this case, a circular slit 8S may be formed in the mounting block 8 to accommodate the cylindrical end unit 73x, and the cylindrical end unit 73x may be adjusted vertically in the slit 8S, followed by fixing the cylindrical end unit 73x with the set screw 11.

In addition, the male screw unit 10a and the female screw unit 10b of the distance adjustment mechanism 10 of the above-mentioned embodiment may be reversed, namely, the male screw unit 10a may be formed on the mounting block 8, and the female screw unit 10b may be formed on the inner circumference of the casing 73.

Furthermore, in addition to the normal open type, the fluid control valve 32 of the above-mentioned embodiment may also be a so-called normal close type that is in a fully closed state when the valve member 6 is not being driven. In accordance with a configuration of the normal close type, in a state wherein no current is flowing in the solenoid coil 72, the valve member 6 is held in a fully closed state and urged against the valve seat member 5 by an elastic body such as the support member 9. Then, by passing an electric current in the solenoid coil 72, the core 71 and the permanent magnet 60 are attracted to each other, causing the valve member 6 to move in the direction of opening the valve.

In addition, in the above-mentioned embodiment, the fluid control valve 32 is configured to locate in the upstream side of the flow rate sensor 31, however, it may also be configured to locate in the downstream side of the flow rate sensor 31.

In the above-mentioned embodiment, a pressure-type flow sensor is used as the flow sensor 31 of the fluid control device 100, however, a thermal flow sensor may also be used. In this case, it is conceivable that a thermal flow sensor is arranged in an upstream side of the fluid control valve 32. In addition to the flow sensor, a fluid sensor such as a pressure sensor may also be used.

In addition, the fluid control device 100 may not be limited to pressure-type or thermal-type devices and may be a device that has a position sensor that measures a relative position of the valve seat surface 5a and the seating surface 6a in the fluid control valve 32, and that feedback-controls the valve opening based on a measurement value of the position sensor. In addition, the fluid control device of this invention is not limited to the flow control device of the above-mentioned embodiment and can also be applied to a pressure control device that controls the pressure of a fluid.

In addition, various modifications and combinations are possible without departing from a spirit of this invention.

### Applications in Industry

In accordance with the present invention, it is possible to simplify the valve structure, the dead volume is reduced, and the device can be used in semiconductor manufacturing processes.

### REFERENCE CHARACTER LIST

100 . . . fluid control device
2 . . . flow channel block
2R . . . internal flow channel
2M . . . housing recess
32 . . . fluid control valve
31 . . . fluid sensor
4 . . . valve control unit
5 . . . valve seat member
5a . . . valve seat surface
6 . . . valve member
6a . . . seating surface
60 . . . permanent magnet
61 . . . valve body
62 . . . sealing member
7 . . . actuator
71 . . . core
72 . . . solenoid coil
73 . . . casing
73x . . . cylindrical end unit
8 . . . mounting block
8S . . . circular slit
811 . . . radially outer side wall part
812 . . . radially inner side wall part
10 . . . distance adjustment mechanism
10a . . . male screw unit
10b . . . female screw unit
11 . . . set screw

1. A fluid control valve comprising
a flow channel block on which an internal flow channel is formed,
a valve seat member that has a valve seat surface,
a valve member that has a seating surface that seats on the valve seat surface and that is provided with a permanent magnet, and
an actuator that drives the valve member by acting on the permanent magnet, wherein
the permanent magnet is sealed by a corrosion-resistant alloy.

2. The fluid control valve described in claim 1, wherein
the actuator comprises
a core provided on an opposite side to the seating surface of the valve member, and
a solenoid coil wound around the core,
in case that the solenoid coil is not energized, the permanent magnet is adsorbed to the core, causing the valve member to be fully open, and
in case that the solenoid coil is energized, the core and the permanent magnet repel each other, causing the valve member to move in the direction of closing the valve.

3. The fluid control valve described in claim 1, wherein
the valve member comprises
a valve body that is made of a corrosion-resistant alloy and that is provided with a recess to house the permanent magnet on a surface opposite to the seating surface, and
a sealing member that is made of the corrosion-resistant alloy and that seals an opening of the recess in a state wherein the permanent magnet is housed in the recess.

4. The fluid control valve described in claim 1, wherein
the corrosion-resistant alloy is stainless steel.

5. The fluid control valve described in claim 3, wherein
the valve body is made of electromagnetic stainless steel, and
the sealing member is made of non-magnetic stainless steel.

6. The fluid control valve described in claim 2, further comprising
a distance adjustment mechanism that adjusts distance between the core and the valve member.

7. The fluid control valve described in claim 6, further comprising
a mounting block that is mounted on the flow channel block and that houses the valve member, wherein
the actuator has a casing that houses the core and the solenoid coil,
the core is fixed to the casing, and
the distance adjustment mechanism comprises the casing and the mounting block.

8. The fluid control valve described in claim 7, wherein
the distance adjustment mechanism has
a male screw unit that is formed on either one of an outer circumference of the casing and the mounting block, and
a female screw unit that is formed on the other of the outer circumference of the casing and the mounting block and into which the male screw unit screws.

9. The fluid control valve described in claim 8, wherein
the mounting block is provided with a fixing unit that is movable back and forth in relation to the casing and that fixes the casing to the mounting block.

10. The fluid control valve described in claim 9, wherein
the casing has a cylindrical end unit at a distal end part on a flow channel block side,
the mounting block has a slit that houses the cylindrical end unit,
the fixing unit is provided on a side wall part that forms the slit of the mounting block, and
the cylindrical end unit is fixed to the side wall part that forms the slit of the mounting block by the fixing unit.

11. The fluid control valve described in claim 7, wherein
the flow channel block has a housing recess that houses the valve seat member.

12. The fluid control valve described in claim 11, wherein
the mounting block fixes the valve seat member housed in the housing recess by being mounted on the flow channel block.

13. A fluid control device comprising
a fluid control valve described in claim 1
a fluid sensor that measures a flow rate or a pressure of a fluid, and
a control unit that controls an opening degree of the fluid control valve based on a measured value measured by the fluid sensor and a predetermined target value.
